(19) United States
(12) Patent Application Publication
(10) Pub. No.: US 2008/0046710 A1
(43) Pub. Date: Feb. 21, 2008

(54) Switching firmware images in storage systems

(76) Inventors: Steven Maddocks, Ft. Collins, CO (US); John G. McCarthy, Ft. Collins, CO (US); Alexandre Lenart, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/505,962

(22) Filed: Aug. 17, 2006

(51) Int. Cl. G06F 9/00; G06F 15/177

(52) U.S. Cl. 713/2

(57) ABSTRACT

Embodiments include methods, apparatus, and systems for switching firmware images in storage systems. One method of software execution includes transferring a new firmware image to a secondary storage location in an automated storage system while the automated storage system is online to execute a data backup application; and rebooting a drive in the automated storage system to switch to the new firmware image

### BACKGROUND

Automated storage systems are commonly used to store large volumes of data on various types of storage media, such as magnetic tape cartridges, optical storage media, and hard disk drives, to name only a few examples. System devices in the storage system are logically configured or “mapped” for user access over a network. For example, the users are given access to one or more data access drives, for read and/or write operations, and to transfer robotics to move the storage media between storage cells and the data access drives.

Drives in the automated storage system are periodically updated with new or revised firmware images. The task of downloading firmware to such drives, however, can be complex, inconvenient, and inefficient. For instance, an administrator of the storage system first manually searches for an appropriate firmware upgrade to download to the storage system. Next, the administrator manually searches for and selects a particular drive to update. The administrator must ensure that no backups or restorations are taking place while the drive is rebooted and the upgrade installed. Updating multiple drives in a single library can take from thirty minutes to several hours. The storage system is taken offline and backup applications are shut down during the firmware installation.

Managing firmware in a storage system is a sizeable task that tape library administrators seek to postpone until absolutely necessary due to the effort and downtime involved. In addition, administrators are often suspicious that new firmware may in fact create new problems or aggravate existing ones in the storage system. Administrators thus often limit a firmware upgrade to a limited number of drives, perhaps even just one tape drive. After a single drive is updated, a firmware test is performed on the drive to determine if the drive is properly functioning. If the test is successful, then the firmware installation process is repeated for one or all of their drives. For systems with multiple drives, the administrator manually tracks which tape drives were updated and which were not and repeats the download process.

If the limited drive test of the new firmware is not successful, then the administrator is generally not able to change the firmware back to its original level. Because administrators cannot easily and quickly revert to a previous revision of firmware, they are reluctant to perform firmware upgrades. As such, many storage systems, such as tape libraries, use old or outdated firmware. Storage systems with old firmware are more prone to experience unnecessary failures, and these failures result in use of additional technical support resources and downtime for the storage system.

### BRIEF DESCRIPTION OF THE DRAWINGS

FIG. 1 is an exemplary storage network and storage system in accordance with an exemplary embodiment of the present invention.

FIG. 2 is a functional diagram illustrating an exemplary interface manager and user interface in accordance with an exemplary embodiment of the present invention.

FIG. 3 is an exemplary flow diagram for managing firmware images in a storage system in accordance with an exemplary embodiment of the present invention.

### DETAILED DESCRIPTION

Embodiments in accordance with the present invention are directed to apparatus, systems, and methods for managing firmware images in automated storage systems. In one exemplary embodiment, new firmware images are downloaded and stored in one or more secondary locations in the storage system while the storage system continues to operate using pre-existing firmware images. These new firmware images are then activated for the drives according to policies previously established by a user or administrator. For instance, upon clicking or activating a single command (example, a user interface button), one or more selected drives reboot and switch over to the new or appropriate firmware images located in the secondary storage locations. Users are thus able to upgrade to new firmware images in a single step, as opposed to multiple time-consuming steps.

Firmware images are obtained and managed using a policy-based mechanism that is defined through input from a user. A variety of different policies are used to provide a flexible system to manage the capture and transition to new firmware, such as firmware upgrades. In one exemplary embodiment, firmware images are preloaded into a secondary firmware image location, and firmware downloads are transparently performed in a background of the storage system. Any glitches with the download operation are automatically retried without concerning or involving an administrator or user since such downloads are not occurring at an urgent time (example, during data backup or restoration). The storage systems are not taken offline for large amounts of time to perform firmware download maintenance. In one exemplary embodiment, the storage system or particular drives are only offline while the system performs a reboot. The process of obtaining and launching new firmware images is fast and reliable. Further, administrators are able to holistically manage the storage system (example, tape library) instead of or in addition to managing individual libraries and individual drives.

One exemplary embodiment enables users to easily and quickly switch back or revert to previous firmware images. New firmware images are stored in one location, while old or previous firmware images are stored in another location. The drives are booted from either of the locations according to policies specified by a user or administrator. Users are thus more apt to obtain and utilize the latest firmware images since the system reverts to a previous firmware version if the new version does not perform satisfactorily. Having the ability to switch to or activate the new firmware image on the next drive unload enables an administrator to not even have to shut down their backup application at all and makes the whole procedure even less intrusive and more transparent to their operating environment.

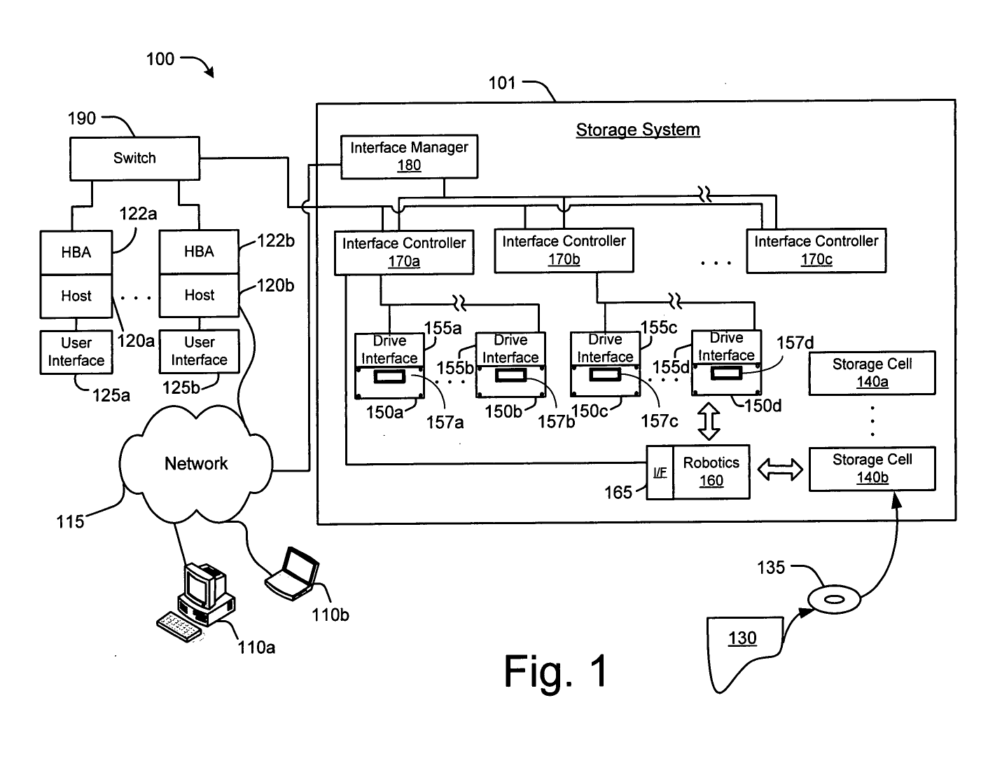

FIG. 1 illustrates an exemplary storage area network (SAN) or storage network 100. The storage network 100 is implemented in a private, dedicated network, such as a Fibre Channel (FC) switching fabric. Alternatively, portions of the storage network 100 are implemented using public communication networks (such as the internet) pursuant to a suitable communication protocol. Storage network 100 includes an automated storage system 101 that is accessed by one or more clients 110a, 110b through one or hosts, shown as host 120a, 120b.

As used herein, the term “host” comprises one or more computing systems that provide services to other computing or data processing systems or devices. For example, clients 110a, 110b access the storage device 101 via one of the hosts 120a, 120b. Hosts 120a, 120b include one or more processors (or processing units) and system memory, and are typically implemented as server computers.

Clients 110a, 110b are connected to one or more of the hosts 120a, 120b or to the storage system 101 directly or over a network 115, such as a Local Area Network (LAN), Wide Area Network (WAN), the internet, etc. Clients 110a, 110b include memory and a degree of data processing capability at least sufficient to manage a network connection. Typically, clients 110a, 110b are implemented as network devices, such as wireless devices, desktop or laptop computers, workstations, and even as other server computers.

As noted, storage network 100 includes an automated storage system 101 (hereinafter referred to as a “storage system”). Data 130 is stored in the storage system 101 on storage media 135, such as, but not limited to, magnetic data cartridges (such as magnetic tapes), optical media, and hard disk storage, to name only a few examples.

In one exemplary embodiment, the storage system 101 is arranged as one or more libraries (example, tape libraries) having a plurality of storage cells 140a, 140b for the storage media 135. The libraries are modular (example, configured to be stacked one on top of the other and/or side-by-side) and allow the storage system 101 to be readily expanded.

The storage system 101 is not limited to any particular physical configuration. For example, the number of storage cells 140a, 140b depends upon various design considerations. Such considerations include, but are not limited to, the desired storage capacity and frequency with which the computer-readable data 130 is accessed. Still other considerations include, by way of example, the physical dimensions of the storage system 101 and/or its components. Consequently, implementations in accordance with the invention are not to be regarded as being limited to use with any particular type or physical layout of storage system 101.

The storage system 101 includes one or more data access drives 150a, 150b, 150c, 150d (also referred to generally by reference 150) for read and/or write operations on the storage medium 135. In one exemplary implementation, each library in the storage system 101 is provided with at least one data access drive 150. However, in other implementations data access drives 150 do not need to be included with each library.

Transfer robotics 160 are provided for transporting the storage media 135 in the storage system 101. Transfer robotics 160 are generally adapted to retrieve storage media 135 (example, from the storage cells 140a, 140b), transport the storage media 135, and eject the storage media 135 at an intended destination (example, one of the data access drives 150).

Various types of transfer robotics 160 are readily commercially available, and embodiments of the present invention are not limited to any particular implementation. In addition, such transfer robotics 160 are well known and further description of the transfer robotics is not needed to fully understand or to practice embodiments in accordance with the invention.

Further, the storage system 101 is not limited to use with data access drives and transfer robotics. Storage system 101 also includes any of a wide range of other system devices that are now known or that may be developed in the future. For example, a storage system including fixed storage media such as a redundant array of independent disks (RAID) may not include transfer robotics or separate data access drives.

Each of the system devices, such as the data access drives 150 and transfer robotics 160, are controlled by interface controllers 170a, 170b, 170c. The interface controllers are operatively associated with the system devices via the corresponding device interfaces. For example, interface controller 170a is connected to drive interfaces 155a, 155b for data access drives 150a, 150b, respectively. Interface controller 170a is also connected to the robotics interface 165 for transfer robotics 160. Interface controller 170b is connected to drive interfaces 155c, 155d for data access drives 150c, 150d, respectively. Interface controller 170b is also connected to the robotics interface 165 for transfer robotics 160.

In an exemplary implementation, the interface controllers 170a, 170b, 170c are implemented as Fibre Channel (FC) interface controllers; and the device interfaces 155a, 155b, 155c, 155d are implemented as small computer system interface (SCSI) controllers. Exemplary embodiments, however, are not limited to use with any particular type of interface controllers and/or device interfaces.

Storage system 101 also includes an interface manager 180. Interface manager 180 is communicatively coupled, internally, with the interface controllers 170a, 170b, 170c, and aggregates device information and management commands for each of the system devices. The interface manager 180 also allocates the system devices as uniquely identified logical units or LUNs. Each LUN comprises a contiguous range of logical addresses that are addressed by mapping requests from the connection protocol used by the hosts 120a, 120b to the uniquely identified LUN. Exemplary embodiments, though, are not limited to LUN mapping and other types of mapping now known or later developed are also within the scope of exemplary embodiments in accordance with the invention.

Interface manager 180 is also communicatively coupled, externally, to user interfaces 125a, 125b via hosts 120a, 120b and/or clients 110a, 110b. In an exemplary implementation, the hosts 120a, 120b are connected to the storage system 101 by input/output (I/O) adapters 122a, 122b, such as host bus adapters (HBA) to a switch 190. Switch 190 is implemented as a SAN switch and is connected to the storage system 101. Accordingly, the hosts 120a, 120b and/or clients 110a, 110b access system devices, such as the data access drives 150 and transfer robotics 160 via the interface manager 180.

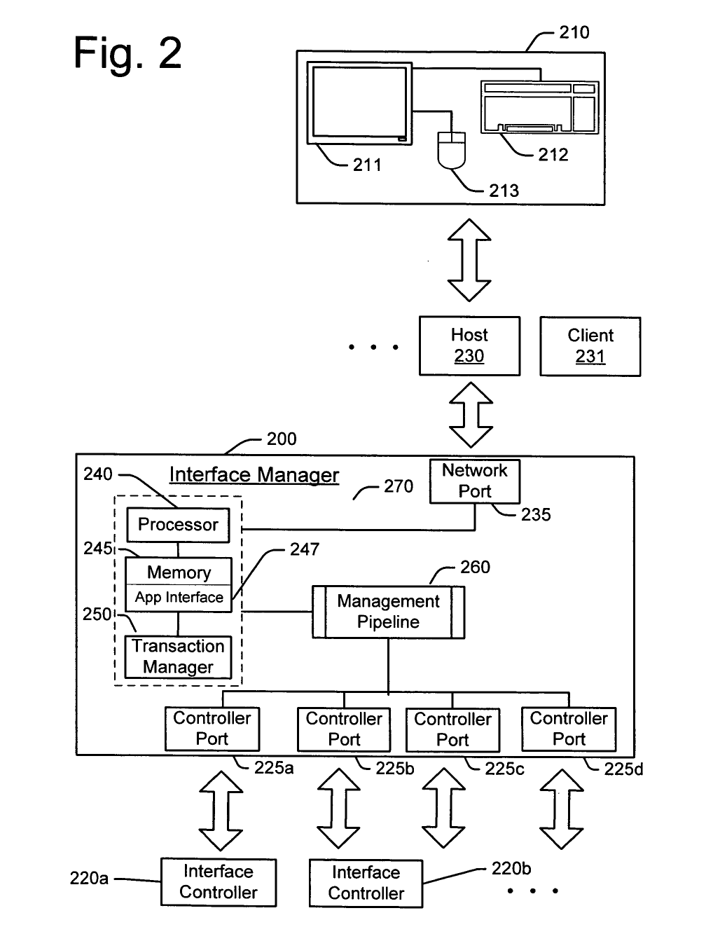

FIG. 2 is a functional diagram illustrating in more detail an exemplary interface manager 200 and user interface 210. Interface manager 200 and user interface 210 are implemented in hardware, software and/or firmware that process computer-readable data signals embodied in one or more carrier waves. Interface manager 200 aggregates device information and management commands for a storage system (example, storage system 101 in FIG. 1). Interface manager 200 outputs device information and receives management commands via the user interface 210 and enables a network administrator (or other user) to centrally manage access to the storage system.

Interface manager 200 communicatively couples interface controllers 220a, 220b to the user interface 210 via hosts 230 and/or clients 231. Accordingly, the interface manager 200 includes a plurality of I/O modules or controller ports 225a, 225b, 225c, 225d (also referred to generally by reference 225). The controller ports 225 facilitate data transfer between the respective interface controllers 220a, 220b. Interface manager 200 also includes at least one network port 235.

In an exemplary implementation, the controller ports 225 and network port(s) 235 employ fiber channel technology, although other bus technologies can also be used. Interface manager 200 also includes a converter (not shown) to convert signals from one bus format (example, Fibre Channel) to another bus format (example, SCSI).

In one exemplary embodiment, the auxiliary components are included with the interface manager 200, such as power supplies to provide power to the other components of the interface manager 200. Auxiliary components are well understood in the art and further description is not necessary to fully understand or to enable the invention.

Interface manager 200 is implemented on a computer board and includes a processor (or processing units) 240 and computer-readable storage or memory 245 (example, dynamic random access memory (DRAM) and/or Flash memory). The memory further includes one or more application programs or application interfaces 247. Interface manager 200 also includes a transaction manager 250 to handle all transactions to and from the interface manager 200, and a management pipeline 260 to process the transactions.

In one exemplary embodiment, the interface manager 200 is in charge of safely transferring the new firmware image to the secondary location in the tape drive. In a tape library for instance, the interface manager 200 tracks the status of each tape drive on power-ups. When new firmware images are received (example, downloaded from the internet), the interface manager automatically verifies that every drive has the most recent firmware without violating the hold time previously specified by the administrator. When the user activates an apply button or menu option, the interface manager requests the specific drive to reboot and switch over to the new (or appropriate) firmware image stored in the secondary location. This apply button causes the interface manager to perform one or more of the following exemplary actions: immediately switch over to firmware in the secondary location, switch over to firmware in the secondary location at the next available and/or safe time for the drive to accept the firmware, switch back to a previous version of firmware stored in the storage system or elsewhere on a network, switch over to new firmware and then test the firmware to determine if it is properly functioning, etc.

The interface manager communicates with the drives (shown in FIG. 1) to perform a plurality of functions, such as, but not limited to, the following: to transfer firmware to its secondary location in robust and reliable method that is not disruptive to any tape media operations; to query the drive what firmware images it has in its primary and secondary locations; to switch its primary and secondary locations; to reboot the drive; and to inform the interface manager when the drive unloads media in case the interface manager is scheduled to reboot the drive at that time. In one exemplary embodiment, when the drive reboots, it loads from the primary location.

User interface 210 includes one or more output devices 211, such as audio and/or video output. User Interface 210 also includes one or more input device, such as a keyboard 212, pointing device 213, and/or microphone (not shown), to name only a few examples. User interface 210 is typically implemented at one or more of the hosts 230 and/or clients 231, although user interface 210 is also implemented at the storage system and/or at one or more clients (example, storage system 101 and/or clients 110a, 110b in FIG. 1). User interface 210 is operatively associated with the interface application 247 (which resides in memory 245 and is executable by processor 240). It is noted, however, that interface application 247 and/or various functional modules thereof alternatively reside on one or more other devices in a storage network.

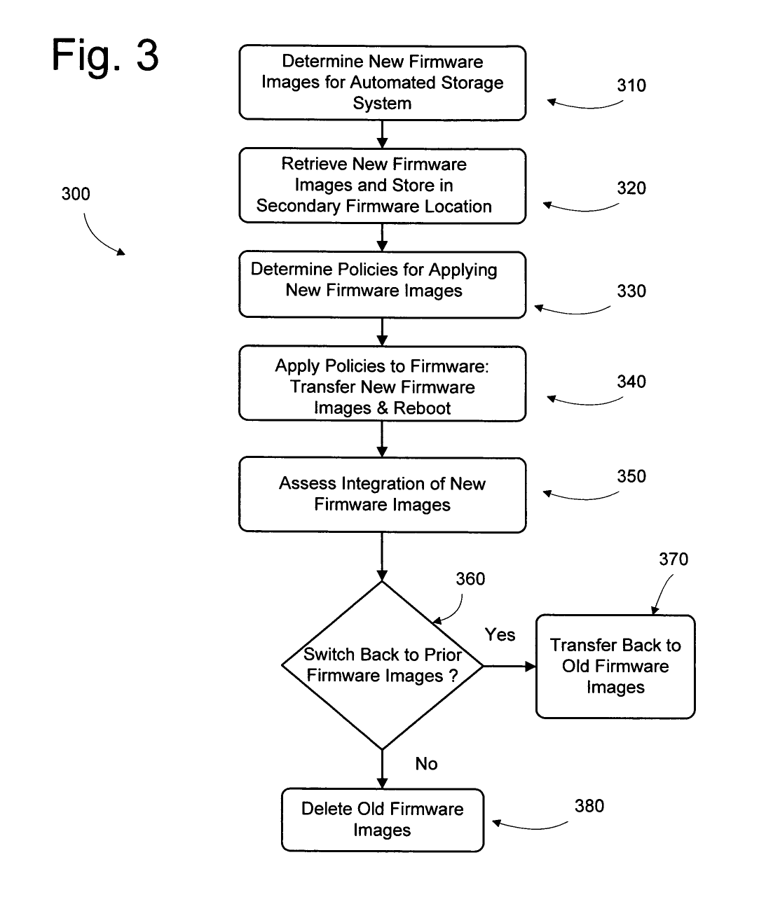

In one exemplary embodiment, the interface application 247 generates a graphical user interface for implementing the flow diagram of FIG. 3. The graphical user interface (such as shown in connection with user interface 210) supports user interaction through common techniques, such as a pointing device (e.g., mouse, style), keystroke operations, touch screen, etc.

In one exemplary embodiment the graphical user interface (GUI) enables a user or administrator to select policies that manage firmware in the storage system. For instance, the GUI enables an administrator to automatically obtain firmware upgrades and download such upgrades into a secondary firmware storage location in the storage system. The GUI further enables the administrator to activate or utilize a single activation button or icon (or single “click”) on any firmware switch-over that is taking place in environment of the storage system. Further, administrators can instruct the storage system to perform one or more firmware switch-overs at a specific time, such as at a next reboot, at a specified time of day, at a time during which no backups or restorations are occurring, right after a drive unload of media, to name a few examples.

Further, the GUI allows the user to easily and quickly switch-back or revert to the previous firmware image that was used in the drive(s). The ability to perform this reversion can be, for example, indefinite, extended for a user specified time period, or extended for a predetermined time period (example, thirty days). Further, the GUI enables a user to specify a time period (example, a hold time) in which the drive firmware will not be updated with a new firmware release as that would over-write the previous firmware image. In one exemplary embodiment, the hold time is specified by the user and enables the user to verify they want to continue to use the current image.

Further, the GUI is responsible for presenting the status of firmware for one or all of the drives in one or all of the libraries in a holistic and user friendly fashion. In one exemplary embodiment, this presentation is performed in the launcher where the user is viewing all the libraries and not managing one specific library.

FIG. 3 is an exemplary flow diagram 300 for managing firmware images in a storage system in accordance with an exemplary embodiment of the present invention. According to block 310, a determination is made as to whether one or more devices (such as drives) in the storage system require or need one or more new or different firmware images. In one exemplary embodiment the interface manager or business logic in the storage system automatically and/or periodically checks for firmware revisions, upgrades, etc. For instance, the storage system accesses the internet, navigates to a website of a vendor or manufacturer having firmware upgrades, and verifies that drives in the storage system have current firmware.

According to block 320, the new firmware images are obtained and stored in one or more secondary firmware locations. Embodiments in accordance with the present invention are not limited to any particular secondary storage location for the new firmware. In one exemplary embodiment, each drive has two or more separate and distinct firmware banks (example, 157a. . . 157d of FIG. 1) for simultaneously storing two of more different firmware images from which a drive can boot. A first or primary bank stores the firmware images from which the drive boots. The second bank stores the new or alternate firmware images. During a boot process or reboot, the drive uses the firmware images stored in the first or primary bank. The contents of the two banks are switched and the drive rebooted in order to have the drive boot with the alternate firmware images. The secondary firmware images thus become the primary firmware images and are used for subsequent booting processes (unless a reversion occurs or the primary bank is switched with new firmware images downloaded to the secondary bank). In another embodiment, the storage system includes one or more flash read only memory (flash ROM) locations, such as memory 245 (FIG. 2), memory in or in communication with the storage system, memory in a host computer, etc.

In one exemplary embodiment, firmware includes one or more software programs or set of instructions programmed on a hardware device and provides instructions so the device can communicate with the other computer hardware. For instance, the firmware is stored in the flash ROM of the hardware device and is both erasable and writable.

According to block 330, a determination is made for the policies for applying the new firmware images that are stored in the secondary firmware location. In one exemplary embodiment, the policies instruct when and how to switch from the current firmware versions to the new firmware versions. The policies provide a user or administrator with flexibility in managing firmware for the storage system. Such policies include, but are not limited to, the following: (1) instructing when in time (example at specified time of day or a specified date) to switch to the new firmware images, (2) instructing which one or ones of the devices and/or drives to switch to the new firmware images, (3) instructing whether one or more tests are performed on the drives receiving the new firmware images to determine if the drives are properly functioning, (4) instructing if one or more drives are concurrently switched to the new firmware and rebooted, (5) instructing conditions for a drive to revert back to a previous version of firmware, (6) instructing a “hold time” during which a drive is not updated with new firmware, (7) instructing when to switch to new firmware and reboot the drive based on performance or usage of a processor or drive, (8) instructing when to switch to new firmware and reboot based on a next available, free, or opportunistic time for a drive to accept the firmware (example, immediately following a drive unload of media), (9) instructing one or more drives to immediately switch and reboot, (10) instructing one or more drives to automatically switch the next time the drive is rebooted for another reason, etc.

According to block 340, the policies of block 330 are applied. At the designated time and manner per the policies, the new firmware images are employed and a reboot of the devices (example, drives) occurs. Such reboots and switching can occur individually and separately for each drive or simultaneously for multiple or all drives.

According to block 350, integration of the new firmware images is assessed. For example, one or more tests are automatically conducted on the drives to determine that the new firmware successfully executed during the boot process and the drive properly functions after the boot and switch processes. Further, one or more tests are conducted to ensure that the new firmware does not create new hardware or software problems with the storage system (such as hardware and/or software compatibility issues with the new firmware). In one embodiment, this test involves running the host-based backup application to verify that no new hardware or software compatibility issues are introduced.

According to block 360, a question is asked: Does a user or policy require a switch-back or reversion to a prior firmware image? If the answer to this question is “yes,” then flow proceeds to block 370 wherein one or more drives are rebooted and a transfer occurs back to the previous or old firmware image. If the answer to this question is “no,” then flow proceeds to block 380 wherein the old firmware images are deleted. For instance, the old firmware images are deleted after a predetermined amount of time (example, thirty days, sixty days, etc.). As another example, the old firmware images remain in the secondary firmware storage locations indefinitely or until they are replaced with a newer version of firmware images that are retrieved according to blocks 310 and 320. For example, after the new firmware images are provided to boot the drives, the system discovers even newer firmware images for one or more drives. These newer firmware images are stored and thus replace the old firmware images. For instance, the newer firmware images are loaded into the secondary firmware locations where the old firmware images were previously stored. As new firmware images become available, they are stored in the storage system and subsequently loaded according to the policies input from the user.

Embodiments in accordance with the present invention are utilized in a variety of systems, methods, and apparatus. For instance, one or more computers or computer systems executes the flow diagram and/or aspects of exemplary embodiments in accordance with the present invention. Embodiments in accordance with the present invention are not limited to any particular type or number of computers or computer systems and include, but are not limited to, computers (portable and non-portable), servers, main frame computers, distributed computing devices, laptops, and other electronic devices and systems whether such devices and systems are portable or non-portable.

In one exemplary embodiment, one or more blocks in the flow diagrams are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory (such as memory of the handheld portable electronic device) and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method of software execution, comprising:
transferring a new firmware image to a secondary storage location in an automated storage system while the automated storage system is online to execute a data backup application; and
rebooting a drive in the automated storage system to switch to the new firmware image.

2) The method of claim 1 further comprising, simultaneously storing in the automated storage system a previous firmware image for the drive and the new firmware image for the drive to enable the drive to reboot and switch between the previous and new firmware images.

3) The method of claim 1 further comprising, receiving instructions from a user for specifying a time when the drive switches to the new firmware image.

4) The method of claim 1 further comprising, querying the drive to determine what firmware images are stored in a primary storage location of the drive and the secondary storage location of the drive.

5) The method of claim 1 further comprising:
automatically navigating over an internet to determine if an updated firmware image is available for the drive;
if the updated firmware is available, then automatically downloading the updated firmware to the secondary storage location.

6) The method of claim 1 further comprising:
rebooting the drive and switching to the new firmware image;
testing to determine if the drive is properly functioning;
if the drive is not properly functioning, then rebooting the drive and switching from the new firmware image back to a previous firmware image that is stored in the drive.

7) A computer readable medium having instructions for causing a computer to execute a method, comprising:
simultaneously storing first and second firmware images for a drive in an automated storage system; and
receiving instructions from a user for rebooting the drive to switch from the first firmware image to the second firmware image.

8) The computer readable medium of claim 7 further comprising, overwriting the first firmware image with the second firmware image after expiration of a hold-time that is specified by the user of the automated storage system.

9) The computer readable medium of claim 7 further comprising, receiving instructions from the user for reverting back to the first firmware image.

10) The computer readable medium of claim 7 further comprising, receiving instructions from the user for (1) storing but not installing an upgraded firmware image for the drive and (2) storing but not deleting a prior firmware image for the drive.

11) The computer readable medium of claim 7 further comprising, receiving instructions from the user for specifying when in time the drive will reboot and switch from the first firmware image to the second firmware image.

12) The computer readable medium of claim 7 further comprising, receiving instructions from the user for specifying whether one or more tests are performed on the drive to determine if the drive is properly functioning after booting from the second firmware image.

13) The computer readable medium of claim 7 further comprising, downloading the second firmware image to a second firmware storage location in the drive while the drive performs a data backup operation.

14) The computer readable medium of claim 7 further comprising:
storing the first firmware image after the drive is rebooted and switched to the second firmware image;
rebooting and switching back to the first firmware image if the drive does not properly function while running from the second firmware image.

15) The computer readable medium of claim 7 further comprising:
querying the drive to identify the first and second firmware images;
automatically navigating over a network to obtain an updated firmware image for the drive;
replacing the second firmware with the updated firmware while the drive is booted from the first firmware image and is online to perform data backup operations.

16) A storage system, comprising:
a memory means for storing an algorithm; and
a processing means for executing the algorithm to reboot a drive in an automated storage system and switch between two different firmware images that are both simultaneously stored in the automated storage system.

17) The storage system of claim 16, wherein the processing means further executes the algorithm to transfer an upgraded firmware image to the drive while the drive is booted from another firmware image and is online to perform data backup operations.

18) The storage system of claim 16, wherein the automated storage system includes a tape library and the drive is a tape drive.

19) The storage system of claim 16, wherein the drive includes (1) a primary storage location to store first firmware images from which the drive is booted and (2) a secondary storage location, separate from the primary storage location, to store second firmware images.

20) The storage system of claim 16, wherein the processing means further executes the algorithm to receive policies from an administrator of the automated storage system for specifying conditions under which the drive reboots and switches between the two different firmware images.
